(19) United States
(12) Patent Application Publication
(10) Pub. No.: US 2014/0201246 A1
(43) Pub. Date: Jul. 17, 2014

(54) Global Contact Lists and Crowd-Sourced Caller Identification

(71) Applicant: Google Inc., Mountain View, CA (US)

(72) Inventors: Daniel Victor Klein, Pittsburgh, PA (US); Dean Kenneth Jackson, Pittsburgh, PA (US)

(21) Appl. No.: 13/904,800

(22) Filed: May 29, 2013

Related U.S. Application Data
(60) Provisional application No. 61/753,340, filed on Jan. 16, 2013.

(51) Int. Cl. G06F 17/30

(52) U.S. Cl. CPC G06F 17/30292
USPC 707/803

(57) ABSTRACT

Implementations of the present disclosure provide for constructing crowd-sourced global contact lists and for providing caller identification functions. Additional implementations of the present disclosure provide for providing spam identification. The systems and methods described herein contemplate aggregating the information stored in multiple local contact lists. The systems and methods further contemplate analyzing and processing the aggregated information in order to construct a global contact list. The analyzing and processing may involve identifying each phone number appearing in any of the local contact lists, identifying all fields associated with those phone numbers, and identifying, for each field contained in the local contact lists, an entry for which the local contact lists exhibit a threshold degree of consensus. The global contact list created from the aggregation of information from local contact lists can be employed to provide caller identification and spam identification features.

### CROSS-REFERENCE TO RELATED APPLICATION

This patent application claims the benefit of U.S. Provisional Patent Application No. 61/753,340, filed Jan. 16, 2013, which is incorporated herein by reference.

### BACKGROUND

In the latter stages of the twentieth century and the early stages of the twenty-first century, the growth of information technologies has dramatically transformed the way humans communicate. Wireless communication technologies have enabled their users to communicate with other users located nearly anywhere at nearly any time. At the same time, advancements in data storage and memory technologies have enabled the electronic storage of large amounts of information pertaining to user of communication technologies. Electronically stored contact lists have rendered the rolodex of past decades obsolete and further facilitated the propagation of wireless communication technologies. Such electronic contact lists are able to store a variety of information beyond simply a name and a phone number. Photos, email addresses, websites, and social network profiles may also be stored in such electronic contact lists.

However, while the proliferation of communication technologies has greatly enhanced the ability of users to initiate and receive desired communications, it has also enabled telemarketers and other sources of unsolicited and often undesired communications to reach their targets more easily. Furthermore, advancements in computer automation have reduced the operational costs such entities face while simultaneously allowing them to be more prolific. Therefore, while the advancements in communications technologies have brought their users numerous advantages, they have not come without drawbacks.

### SUMMARY

Implementations of the present disclosure provide systems and methods for constructing crowd-sourced global contact lists and for providing caller identification functions. Furthermore, additional implementations of the present disclosure provide for providing spam identification functions. The systems and methods described herein contemplate aggregating the information stored in multiple local contact lists. Local contact lists include but are not limited to contact lists stored in the local memory of a client device or contact lists linked to or associated with one or more user accounts. After the aggregation of local contact list information, the systems and methods described herein contemplate analyzing and processing the aggregated information in order to construct a global contact list. In some implementations, the analyzing and processing comprises identifying each phone number appearing in any of the local contact lists and identifying all fields associated with those phone numbers. The analyzing and processing may further include, for each field, identifying entries for the field for which the local contact lists exhibit a threshold degree of consensus. In such implementations, each field for which a consensus entry exists is included with the phone number and populated with the consensus entry.

One implementation consists of a method for constructing a crowd-sourced global contact list, the global contact list comprising one or more contacts, one or more fields associated with each contact, and an entry corresponding to each of the one or more fields, the method comprising, aggregating information stored at one or more local contact lists, determining, from the aggregated information, a set of unique identifiers, wherein each unique identifier corresponds to a single contact, determining, for each contact, a set of entries for each field associated with the contact, wherein each entry is associated with the unique identifier defining the contact in one or more of the local contact lists, determining, for each contact, whether a consensus entry exists for each field associated with the contact, wherein a consensus entry exists if a unique entry is associated with the unique identifier in a threshold percentage of the local contact lists that contain the unique identifier, and populating each field for each contact in the global contact list for which a consensus entry exists with the consensus entry corresponding to that field.

An additional implementation consists of a system for constructing and maintaining a crowd-sourced global contact list, the global contact list comprising one or more contacts, one or more fields associated with each contact, and an entry corresponding to each of the one or more fields, the system comprising a server, configured to receive local contact list data, to aggregate local contact list data, to determine, from the aggregated local contact list data, a set of unique identifiers wherein each identifier corresponds to a single contact, to determine, for each contact, a set of entries for each field associated with the contact wherein each entry is associated with the unique identifier defining the contact in one or more of the local contact lists, to determine, for each contact, whether a consensus entry exists for each field associated with the contact wherein a consensus entry exists if a unique entry is associated with the unique identifier in a threshold percentage of the local contact lists that contain the unique identifier, and to populate each field for each contact in the global contact list for which a consensus entry exists with the consensus entry corresponding to that field, and a database, configured to store local contact list data and the global contact list data.

A further implementation consists of a method implemented at a computer readable medium for providing caller identification information to a recipient of a call, wherein the caller identification information is generated from a crowd-sourced global contact list, the method comprising receiving a notification that a call was placed to a called client, receiving information pertaining to a caller that placed the call, identifying, from the information pertaining to the caller, a contact in the crowd-sourced global contact list, and transmitting information pertaining to the caller to the called client.

### BRIEF DESCRIPTION OF THE DRAWINGS

FIG. 1 is a block diagram of an example environment in which the methodology for constructing global contact lists and crowd-sourcing caller identification functions may be implemented;

FIG. 2 is a block diagram of the basic functional components for a client in FIG. 1, according to one aspect of the disclosure;

FIG. 3 is a block diagram of the basic functional components for a server, according to one aspect of the disclosure;

FIG. 4 is a flow diagram illustrating an example method for aggregating multiple local contact lists to construct a global contact list and for providing information pertaining to a caller;

FIG. 5 is a depiction of a subset of an aggregated contact list information array generated from subsets of two local contact lists;

FIG. 6 is a depiction of an example subset of a data structure for an array of aggregated contact list information and an example subset of a global contact list derived from the array of aggregated contact list information;

FIG. 7 is a flow diagram illustrating an example method for detecting spam calls through crowd sourced call identification; and

FIG. 8 is a flow diagram illustrating an example method for processing an incoming call according to one embodiment of the present disclosure.

### DETAILED DESCRIPTION

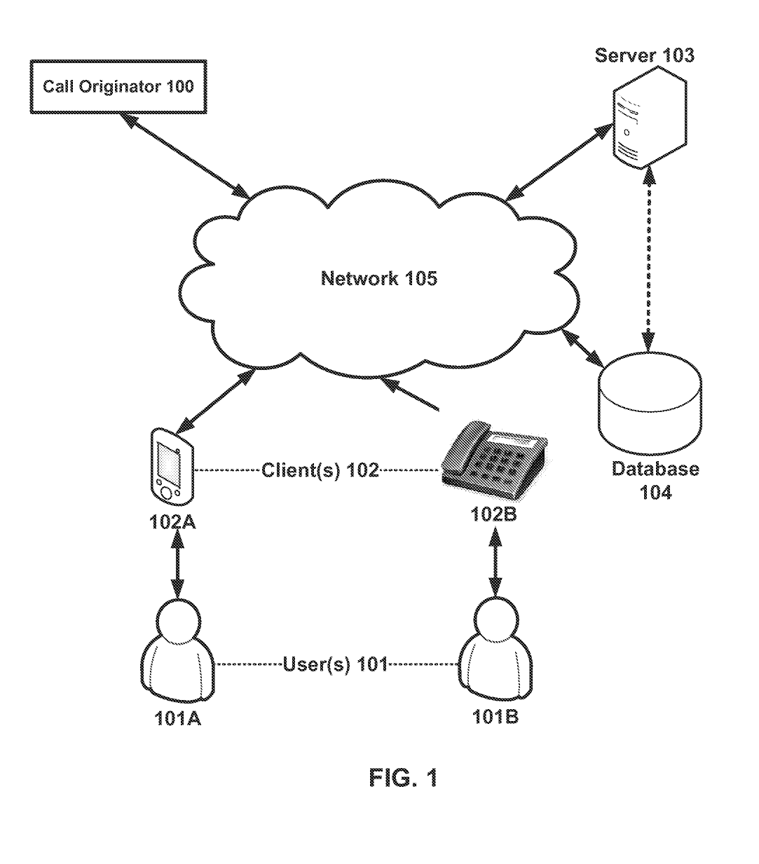

FIG. 1 depicts an example environment in which implementations of the methods and systems for constructing crowd-sourced global contact lists and providing caller identification functions can be practiced. The example environment depicted in FIG. 1 includes a call originator 100. The call originator 100 can make a call to a client 102. The call is transmitted to the client 102 through network 105. Network 105 may include elements of a cellular network, a voice over internet protocol (VoIP) network, a public switched telephone network (PSTN), or a combination thereof. Client(s) 102 may include but are not limited to smart phones, computers, tablet computers, telephones connected to plain old telephone service (POTS) lines, telephones connected to internet protocol (IP) private branch exchange (PBX) systems, and telephones connected to VoIP gateways. Clients 102 depicted in FIG. 1 may consist of multiple components. For example, client 102B may consist of a telephone connected to a POTS line and a call interceptor. Users 101 may operate clients 102. Furthermore, users 101 may establish user accounts. User accounts and data affiliated with the accounts may be stored at clients 102, at a server 103, at a database 104, or at a combination thereof.

The example environment further includes the server 103. Server 103 is connected to clients 102 through network 105. Server 103 is capable of both receiving information from and transmitting information to clients 102. For example, server 103 can receive information associated with a call made by call originator 100 to client 102A or client 102B. Such information may include but is not limited to information contained in a caller line identification (CLID) field received by client 102A or 102B during receipt of a call from call originator 100. Server 103 can also transmit information to the client device, such as a spam score associated with the CLID field. In some implementations, information is not shared with other users unless the owner of the information permits it to be shared. In such implementations, if the owner of a phone number permits information stored at one or more contact lists and pertaining to the phone number owned by the owner to be shared with recipients of calls from the phone number, the server 103 may transmit information associated, in the contact lists, with the phone number to a call recipient. For example, if the owner of a phone number permits an email address or a social network profile associated with that phone number to be shared with recipients of calls from that phone number, the server 103 may provide such information to recipients of calls from that phone number.

Database 104 is connected to server 103 and is configured to store information associated with phone numbers and CLID field. Specifically, database 104 is configured to store information necessary to implement the systems and methods for constructing crowd-sourced global contact lists and performing caller identification functionality as outlined in this disclosure. In some implementations, information is not stored at the database unless the owner of the information permits it to be stored at the database or unless the entity to whom the information pertains permits it to be stored at the database. Some implementations do not allow information to be stored unless both the owner of the information and the entity to whom the information pertains provide permission for the information to be stored at the database. Information stored at database 104 may include but is not limited to a number of times, or frequency, that a telephone number has been designated as spam by clients, users or user accounts, the identities of the users, user accounts, or clients who have designated a particular number as spam, the categories of spam clients or user accounts have designated as representative of a particular number, and any other information a user, user account, or client may tag a number with. Furthermore, database 104 is configured to store information that is available from local contact lists, i.e. contact lists stored on clients, affiliated with user accounts, or a combination thereof. In some implementations, the user, user account, or client to whom the information available from the local contact list pertains must provide authorization to the database to store such information. For example, a user, user account, or client affiliated with the number 111.555.2222 must authorize the database to store any information affiliated with that number. Information available from local contact lists may include but is not limited to names of people or entities associated with particular numbers by one or more local contact lists, designations of particular numbers as mobile numbers, work numbers, or home numbers, email addresses associated with particular numbers, social network profiles associated with particular numbers, photographs associated with particular numbers, various user accounts associated with particular numbers, aliases for a user associated with a particular number, and any additional information that may be included in the contact lists. In some implementations, database 104 is part of server 103.

Implementations of the present disclosure provide systems and methods for constructing crowd-sourced global contact lists and for providing caller identification functions. Furthermore, additional implementations of the present disclosure provide for providing spam identification functions. The systems and methods described herein contemplate aggregating the information stored in multiple local contact lists. Local contact lists include but are not limited to contact lists stored in the local memory of a client device or contact lists linked to or associated with one or more user accounts. After the aggregation of local contact list information, the systems and methods described herein contemplate analyzing and processing the aggregated information in order to construct a global contact list. In some implementations, the analyzing and processing comprises identifying each phone number appearing in any of the local contact lists and identifying all fields associated with those phone numbers. The analyzing and processing may further include, for each field, identifying entries for the field for which the local contact lists exhibit a threshold degree of consensus. In such implementations, each field for which a consensus entry exists is included with the phone number and populated with the consensus entry.

An abundance of information is stored in the local contacts lists of subscribers to services. Such services include but are not limited to the wireless communications services provided by a wireless carrier network, the social networking services provided by a social network website, and the email services provided by an email provider. In general, any service provider who allows its subscribers to create and store contact lists may potentially have access to an abundance of contact information. Implementations of the present invention contemplate making use of such information to generate global contact lists and to provide caller identification and spam identification features. In some implementations, the client device or user account at which the contact lists are stored must grant permission to the entity that creates a global contact lists in order for the entity to utilize the information contained in the contact lists. Similarly, some implementations also require that a user account or client associated with the phone number to which the contact list information pertains must provide the systems and methods with permission to aggregate and utilize such information.

The information stored at the local contact lists is often indexed by a data field corresponding to the name of the user associated with the contact information. Specifically, the information in local contact lists is often organized by entries for a name field. In other words, in order to locate a piece of information in the contact list, the name of the contact to whom the information pertains must first be identified. However, the information stored in the global contact list need not be indexed by name. Although the contact information in the global contact list may be indexed by name in some implementations, in other implementations it may be indexed by number. In some implementations, the information in the global contact list may be indexed, or ordered, by any field in the global contact list or by any field in a subset of primary fields in the global contact list.

In order to generate a global contact list, all or part of the information in the local contact lists to which the global contact list creating service has permission to access and actual access is aggregated. A unique identifier for each entry, e.g. a phone number, is identified and all information associated (in any of the local contact lists) with the unique identifier is analyzed and processed. In some implementations, the analysis and processing involves identifying each entry for each field in any of the local contact lists and identifying a single entry for, if any, for each field included in the global contact list. The single entry that is to be included in the global contact list is an entry that the group of local contact lists exhibit a consensus with respect to. Specifically, an entry for a field in the global contact list is included if a threshold number of local contact lists that contained the unique identifier contained that entry or an equivalent or sufficiently similar entry. Such equivalent or sufficiently similar entries may be determined by checksum, sounds-like, phonetic, or fuzzy matches of the entry. Examples of a sounds-like match include but are not limited to matches identified by Levenstein Distance, Soundex, and Metaphone algorithms. In some implementations, only the local contact lists that both included the unique identifier and an entry for the particular field are considered in determining whether there is a consensus. In some implementations, some entries in some contact lists are disregarded for the purposes of determining a consensus. In determining which entries or contact lists are to be disregarded, an age component of the entry or of the entire contact list may be considered. For example, entries in contact lists associated with a user account may be disregarded if the user account has not existed for a threshold period of time, e.g. one month. Similarly, entries that have not existed for a threshold period of time may also be disregarded. A contact list may be associated with a user account that has existed for several years, but a particular entry in the contact list may be only a day old. In some implementations, that entry that is only day old will be disregarded for the purposes of determining consensus information to be included in the global contact list.

In addition to creating a global contact list, the systems and methods described herein also provide a variety of caller identification features. Upon receiving a call, a client device or a call processing service may query a server with access to the global contact list and request information pertaining to the number from which the call originated. Thereupon, the client device or call processing service may provide the information associated with the number from which the incoming call originated at the same time or shortly after the incoming call is registered at the recipient client. In this manner, caller information is provided to a call recipient even if the caller information is not stored in any of the call recipient's local contact lists. In some implementations, the caller information may be provided to the call recipient only if the caller has granted permission for such information to be provided to call recipients. In some implementations, the global contact list may associate a spam identification score with the caller. In such implementations, the caller information provided to the call recipient may indicate that the call is a spam call or that the call is likely to be spam. The caller information may also include information pertaining to the type of spam call.

The process of providing caller identification features using the information contained in a global contact list may further involve comparing the information pertaining to a particular number that is stored in the global contact list with information pertaining to the same number that is stored at a local contact list. In some implementations, for the purposes of providing caller identification features, information stored at a local contact list is deemed to be authoritative and conflicts between information stored at the local contact list and information stored at the global contact list will be resolved in favor of the information stored at the local contact list. For example, if the global contact list associates a particular contact name with a particular number and the local contact list associates a different contact name with the same number, the process of providing caller identification features may involve determining that the contact name stored at the local contact list should be displayed at a client device and the contact name stored at the global contact list should not be displayed at the client device. Some implementations may involve displaying both the information stored at the local contact list and at the global contact list but displaying the information stored at the local contact list more prominently. Furthermore, for the purposes of determining a hierarchy between information stored at a local contact list and information stored at a global contact list, different rules may apply to different types of information. Similarly, rules may be defined that classify the priority of information stored at a global contact list or at a local contact list based on the origination characteristics of the information stored at either or both of the local contact list and the global contact list. For example, a rule may be defined that determines that information pushed to a global contact list by a client associated with the number to which the information corresponds should supersede any information stored at a local contact list. In some implementations, the information pushed to the global contact list will supersede information stored at a local contact list for only certain types of information.

The global contact list creating service may also provide additional features that allow the local contact lists associated with a client device or user account to be updated with information contained in the global contact list. In some implementations, the client device receiving the call may present the user with the option to store the information contained in the global contact list and associated with the incoming caller in a local contact list. In some implementations, the client device receiving the call will automatically store the information stored at the global contact list and pertaining to the caller after the client device has received a threshold number of calls from the caller, placed a threshold number of calls to the caller, or has connected with or has attempted to connect with the caller a threshold number of times. Implementations may also enable a client device to update information stored at a local contact list with information stored at a global contact list if an error in the information stored at the local contact list is identified.

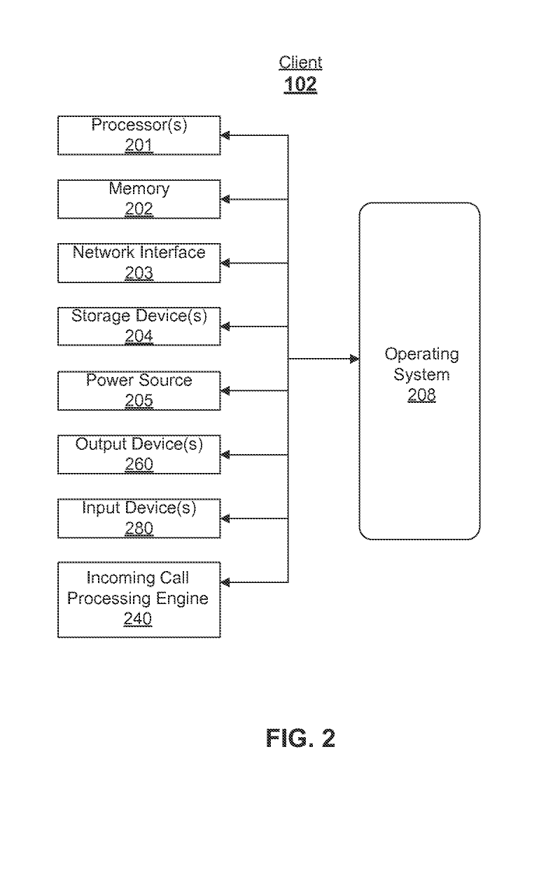

Turning now to FIG. 2, one particular example of a client 102 is illustrated. In general, many other embodiments of the client 102 may be used as long as the embodiment is capable of receiving a call from a call originator and receiving CLID data or other information associated with the call. In the illustrated embodiment of FIG. 2, the client 102 includes one or more processors 201, memory 202, a network interface 203, one or more storage devices 204, a power source 205, one or more output devices 260, and one or more input devices 280. The client 102 also includes an operating system 208, which is executable by the client 102, and an incoming call processing engine 240. In a conventional fashion, each of components 201, 202, 203, 204, 205, 260, 280, 208, and 240 are interconnected physically, communicatively, and/or operatively for inter-component communications.

As illustrated, processors 201 are configured to implement functionality and/or process instructions for execution within client 102. For example, processors 201 execute instructions stored in memory 202 or instructions stored on storage devices 204. Memory 202, which may be a non-transient, computer-readable storage medium, is configured to store information within client 102 during operation. In some embodiments, memory 202 includes a temporary memory, i.e. an area for information not to be maintained when the client 102 is turned off. Examples of such temporary memory include volatile memories such as random access memories (RAM), dynamic random access memories (DRAM), and static random access memories (SRAM). Memory 202 also maintains program instructions for execution by the processors 201.

Storage devices 204 also include one or more non-transient computer-readable storage media. Storage devices 204 are generally configured to store larger amounts of information than memory 202. Storage devices 204 may further be configured for long-term storage of information. In some examples, storage devices 204 include non-volatile storage elements. Examples of non-volatile storage elements include but are not limited to magnetic hard discs, optical discs, floppy discs, flash memories, or forms of electrically programmable memories (EPROM) or electrically erasable and programmable (EEPROM) memories.

The client 102 uses network interface 203 to communicate with external devices via one or more networks, such as the network 105 of FIG. 1, a WLAN network, a WPAN network, or various other networks. Networks through which network interface 203 facilitates communication may include one or more wireless networks, wired networks, fiber optics networks, and other types of networks through which communication between the client 102 and an external device may be established. Network interface 203 may be a network interface card, such as an Ethernet card, an optical transceiver, a radio frequency transceiver, or any other type of device that can send and receive information. Other non-limiting examples of network interfaces include Bluetooth®, 3G and WiFi radios in mobile computing devices, and USB.

The client 102 includes one or more input devices 280. Input devices 280 are configured to receive input from a user through tactile, audio, and/or video feedback. Non-limiting examples of input device 280 include a presence-sensitive screen, a mouse, a keyboard, a voice responsive system, video camera, microphone or any other type of device for detecting a command from a user. In some examples, a presence-sensitive screen includes a touch-sensitive screen.

One or more output devices 260 are also included in client 102. Output devices 260 are configured to provide output to a user using tactile, audio, and/or video stimuli. Output device 260 may include a display screen (which may be part of a presence-sensitive screen), a sound card, a video graphics adapter card, or any other type of device for converting a signal into an appropriate form understandable to humans or machines. Additional examples of output device 260 include a speaker, a cathode ray tube (CRT) monitor, a liquid crystal display (LCD), or any other type of device that can generate intelligible output to a user.

The client 102 includes one or more power sources 205 to provide power to the client. Non-limiting examples of power source 205 include single-use power sources, rechargeable power sources, and/or power sources developed from nickel-cadmium, lithium-ion, or other suitable material.

The client 102 includes an operating system 208. The operating system 208 controls operations of the components of the client 102. For example, the operating system 208 facilitates the interaction of incoming call processing engine 240 with processors 201, memory 202, network interface 203, storage device(s) 204, input devices 280, and output devices 260.

Incoming call processing engine 240 typically includes program instructions and/or data that are executable by the client 102. In some embodiments, incoming call processing engine 240 is a part of operating system 208 executing on the client 102. The program instructions and data included in the incoming call processing engine 240 may include but are not limited to instructions for requesting information associated with the number from which the call originated, for displaying information stored in a global contact list and associated with the number from which the call originated, for issuing a prompt to add the information stored in the global contact list and associated with the user to one or more local contact lists, for comparing the information stored in one or more local contact lists with information received from a global contact list, and for determining that the information stored at one or more of the local contact lists should replace, or take priority over, information received form a global contact list.

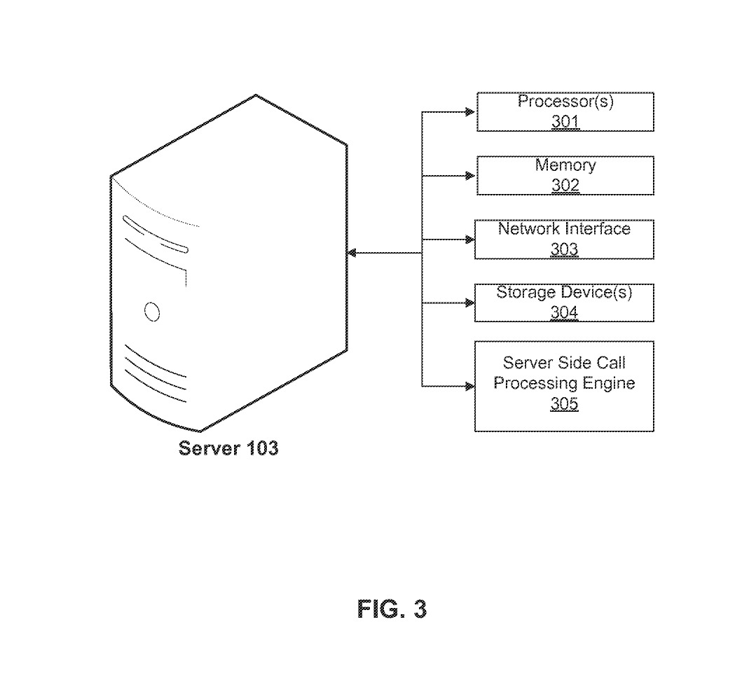

Moving to FIG. 3, a block diagram of basic functional components for a server 103, according to one aspect of the disclosure, is depicted. The server 103 includes one or more processors 301, memory 302, a network interface 303, one or more storage devices 304, and a connection record engine 305. In a conventional fashion, each of components 301, 302, 303, 304, and 305 are interconnected physically, communicatively, and/or operatively for inter-component communications.

As illustrated, processors 301 are configured to implement functionality and/or process instructions for execution within the server 103. For example, processors 301 execute instructions stored in memory 302 or instructions stored on storage devices 304. Memory 302, which may be a non-transient, computer-readable storage medium, is configured to store information within the server 103 during operation. In some embodiments, memory 302 includes a temporary memory, i.e. an area for information to be maintained when the server 103 is turned off. Examples of such temporary memory include volatile memories such as random access memories (RAM), dynamic random access memories (DRAM), and static random access memories (SRAM). Memory 302 also maintains program instructions for execution by the processors 301.

Storage devices 304 also include one or more non-transient computer-readable storage media. Storage devices 304 are generally configured to store larger amounts of information than memory 302. Storage devices 304 may further be configured for long-term storage of information. In some examples, storage devices 304 include non-volatile storage elements. Non-limiting examples of non-volatile storage elements include magnetic hard discs, optical discs, floppy discs, flash memories, or forms of electrically programmable memories (EPROM) or electrically erasable and programmable (EEPROM) memories.

The server 103 uses network interface 303 to communicate with external devices via one or more networks, such as the network 105 of FIG. 1. Such networks may include one or more wireless networks, wired networks, fiber optics networks, and other types of networks through which communication between the server 103 and an external device may be established. Network interface 303 may be a network interface card, such as an Ethernet card, an optical transceiver, a radio frequency transceiver, or any other type of device that can send and receive information.

The server side call processing engine 305 includes program instructions and/or data that are executable by the server 103. The program instructions and data included in the server side call processing engine 305 may include but are not limited to instructions for identifying an entry in a global contact list associated with a particular phone number or other piece of information, for providing information stored in a global contact list to a client, for providing instructions to a client device to locally store information obtained from a global contact list and sent to the client device, and for comparing information stored at a contact list associated with a user account with information contained in a global contact list.

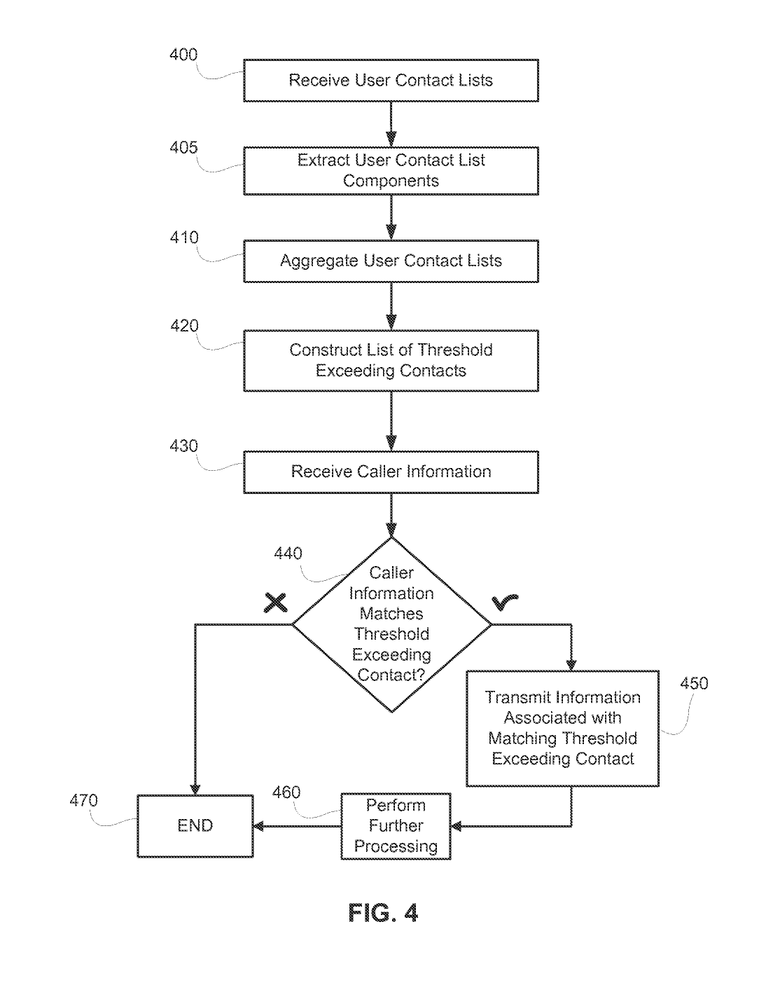

FIG. 4 is a flow diagram illustrating an example method for aggregating data stored at multiple local contact lists, i.e. contact lists stored at clients or contact lists associated with user accounts. Local contact lists may also include contact lists that contain information of which part is stored at one or more client devices and part is associated with one or more user accounts. At 400, a global contact list server receives information stored at local contact lists. In some implementations, the server only receives information stored at local contact lists if the client device or user account at which the contact lists is stored provides permission to the global contact list server to access the information stored at the local contact list. The server may receive the information stored at the local contact lists from a client device. Client devices include but are not limited to cellular phones, smart phones, tablet computers, laptop computers, desktop computers, or personal digital assistants (PDA). The server may also receive the information stored at the local contact lists from another server or from a database. For example, a server or database storing data associated with a user account, including a contact list associated with the user account, may transmit the contact list data to the global contact list server. One of ordinary skill in the art will appreciate that the global contact list server may receive local contact list data from any location at which it is stored provided the storage location and the global contact list server are connected through an appropriate data network and provided the global contact list server has permission to access the local contact lists.

At step 405, contact list components are extracted from the local contact lists. Contact list components include data fields that are associated with each contact found in a contact list and identifiers that populate each data field. The data fields that are associated with a contact in a local contact list may include but are not limited to fields for name, home phone number, work phone number, mobile phone number, email address, home address, employer, social network account, one or more user accounts, and one or more photographs. The information in the local contact lists may be indexed by name or by any other field. Identifiers corresponding to each of the data fields in each of the local contact lists are extracted during step 405. During the extraction, each identifier remains classified by the data field to which it corresponds. For example, the identifier 212.111.2222 corresponding to the field mobile phone number in a local contact list may be extracted during step 405.

At step 410, the local contact lists are aggregated by the global contact list server. During contact list aggregation, the totality of the information stored across multiple local contact lists is assembled by the global contact list server. The server may index information contained in the contact lists by any field and is not constrained by the indexing scheme maintained by local contact lists. Furthermore, in some implementations, the server reorganizes the information in a manner so as to more efficiently employ the information for providing caller identification services. For example, in one implementation, the server creates a list of phone numbers wherein each number is associated with multiple fields of additional information. In doing so, the server compiles a list of all unique numbers stored across all local contact lists received by the server at 400 and populates the fields associated with each unique number with information extracted from the local contact lists that contain the number at step 405. For example, the server may receive twenty contact lists containing 212.555.7777. Fifteen of the contact lists may identify the number as belonging to “John Doe,” three contact lists may identify the number as belonging to “John,” one contact list may identify the number as belonging to “John D,” and one contact list may identify the number as belonging to “J-Money.” Similarly, nineteen of the contact lists may identify 212.555.7777 as a mobile number and one of the contact lists may identify 212.555.7777 as a work number. In some implementations, the global contact list server stores each case, or identifier, for each field associated with a number in any local contact list along with the frequency with which each case appears in the local contact lists. Given the preceding example data, in such implementations, the server would store each of the unique name identifiers for 212.555.7777, i.e. “John Doe,” “John,” “John D,” and “J-Money,” and the frequency with which they exist in the contact lists received at 400, i.e. 15, 3, 1, and 1 respectively. In other implementations, the global contact list server stores only a certain number of the most popular identifiers for each field associated with a particular number. Given the preceding data, if the server was configured to store only the two most popular identifiers for the contact name field, “John Doe” and “John” would be stored on the server while “John D” and “J-Money” would not be stored.

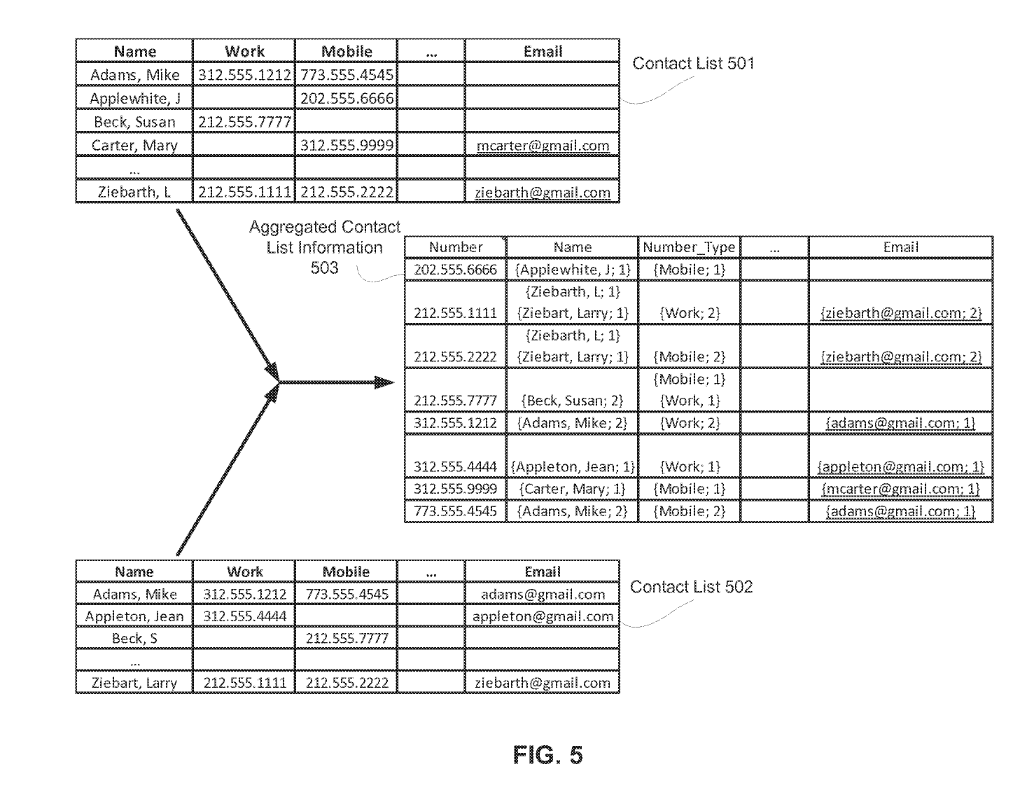

FIG. 5 depicts a subset of an aggregated contact list information array 503 generated from subsets of two local contact lists 501 and 502. Local contact lists 501 and 502 include fields for a contact's name, work number, mobile number, and email address. Local contact lists 501 and 502 may also include other fields that are not depicted in FIG. 5. The information contained in local contact lists 501 and 502 is aggregated and stored in aggregated contact list information array 503. Aggregated contact list information array 503 indexes contact information by phone number and associates identifiers for fields for name, number type, and email. Aggregated contact list information array 503 may also associate identifiers for other fields that are not depicted by FIG. 5. Aggregated contact list information array 503 includes a list of identifiers for each field included in contact lists 501 and 502 and the frequency with which such identifiers appear in contact lists 501 and 502.

Once the global contact list server receives the contact lists and aggregates the contact lists, the global contact list server constructs a list of threshold exceeding contacts at 420. Threshold exceeding contacts are those numbers for which the local contact lists received at 400 exhibit a threshold level of consensus in specifying a single identifier for one or more contact list fields. Threshold levels of consensus may be defined pursuant to a number of different rules and subrules. In general, the rules and subrules are defined in a manner that assists in identifying that a particular phone number is affiliated with a particular user, user account, or client and particular user, user account, or client information. In some implementations, rules and subrules require that contacts be found in a minimum number of the local contact lists received at 400 in order to be included in the threshold exceeding contact list. For example, if two million local contact lists are received at 400 and a unique number is found in only two of those local contact lists, a rule may specify that even though identical identifiers are used for each contact list field in those two local contact lists, the number will not be included in the threshold exceeding contact list because the number was not included in the local contact lists with sufficient frequency. In some implementations, sufficient frequency is defined based on the total number of contact lists received at 400, while in other implementations the definition of sufficient frequency may have no relation to the total number of local contact lists received at 400. Furthermore, rules and subrules may be defined that dictate that certain entries of local contact lists are to be disregarded for the purposes of determining the information that is to be included in the global contact list. Rules and subrules may also be defined that dictate that entire local contact lists are to be disregarded. For example, a rule may be defined that dictates that any local contact list associated with a user account that has not existed for at least thirty days is to be disregarded for the purposes of determining which information is to be included in the global contact list. Similarly, a rule may be defined that dictates that any entry in a local contact list that has not existed for more than five days, regardless of the age of the user account with which the local contact list is associated, is to be disregarded.

The rules and subrules can be defined in such a manner such that the information corresponding to a particular contact list field associated with a particular number need not be identical across all the local contact lists received at 400. Instead, the rules and subrules may allow for some differences in the information corresponding to a particular contact list field associated with a particular number stored at different local contact lists while still ascertaining a single identifier for each of the one or more fields associated with the particular number in the global contact list. Differences in information stored at different contact lists may be attributable to a number of factors including but not limited to misspellings, nicknames, failure to update contact information, idiosyncrasies in relationships, incomplete dissemination of information, and recording errors. In some implementations, the rules and subrules defining the threshold levels of consensus are designed in a manner that balances a desire to limit the number of cases where a particular number is incorrectly associated with an identifier for one or more fields with a desire to maximize the number of cases where an identifier for each of the one or more fields associated with a particular number is correctly ascertained. Rules defining threshold levels of consensus may be defined differently for different fields.

For example, a rule may be defined that matches a name field identifier with a particular number if eighty percent of contact lists containing the particular number associate the name field identifier with that number. Such a rule could be modified so that the name field identifiers associated with that particular number by eighty percent of the contact lists need not be identical but only exhibit a sufficient degree of similarity. In various implementations, a sufficient degree of similarity is defined by checksum, sounds-like, phonetic, or fuzzy matches of the field identifiers, e.g. names of contacts. Examples of a sounds-like match include but are not limited to matches identified by Levenstein Distance, Soundex, and Metaphone algorithms. As an example, assume one hundred contact lists are aggregated and a rule is established that requires eighty percent of contact lists to associate a name field identifier with a number in order for the name field to be linked to the number in the list of threshold exceeding contacts. If seventy-nine contacts list “John Doe” and one contact lists “John Doh,” the name field identifiers may be deemed sufficiently similar to meet the eighty percent requirement. Rules may be defined to deal with situations where an entry for a name field found in some contact lists is a subset of an entry for a name field found in other contact lists. Such a rule may state that a subset of information stored as a name field identifier may be used to determine whether the required percentage of contact lists associate a number with a name. For instance, if one hundred contact lists are aggregated, and forty contact lists associate a particular number with the name field identifier “John” with a particular number, and forty contact lists associate the name field identifier “John Doe” with the same number, a rule may determine that the eighty percent requirement is met because “John” is a subset of “John Doe.”

In some implementations, rules and subrules for handling differences in contact list field identifiers are designed to account for different formats that identifiers may take. For example, rules and subrules may attempt to identify situations where a contact name field includes only a first name, situations where a contact name field includes only a first and last name, and situations where a contact name field includes a first, last, and middle name. Similarly, in particular implementations, rules and subrules are designed to determine the particular identifiers for each field around which the different identifiers stored in different contact lists coalesce.

The rules provided in this section are nothing more than examples and are not meant to imply any limitation regarding the use of other rules or subrules. Furthermore, the examples are not meant to imply any limitation regarding the type of information that may be contained in the list of threshold exceeding contacts nor meant to imply any limitation regarding the types of thresholds that may be established.

The threshold exceeding contacts list may be updated periodically. For example, if the contacts are pushed to the server by clients, such as clients 102, it may be optimal for the server to update the list of threshold exceeding contacts at predetermined intervals, e.g. on an hourly, daily, weekly, biweekly, or monthly basis. Alternatively, if information contained in contact lists is pulled by the server from the clients, it may be optimal for the server to update the list of threshold exceeding contacts each time the contact lists are pulled. In some implementations, contact lists can be pulled periodically by the server, e.g. on an hourly, daily, weekly, biweekly, or monthly basis.

In alternative implementations, the threshold exceeding contact list may include information submitted by a client that corresponds to a particular number. In the event that a client that corresponds to a particular number submits information pertaining to the particular number to which the client corresponds, such submitted information may be deemed to be authoritative. For example, if a client corresponding to the number 123.555.0000 submits information indicating that the proper name field identifier to be associated with 123.555.0000 is “George Washington,” and the proper email address identifier to be associated with 123.555.0000 is georgethefirst@gmail.com, then “George Washington” and “georgethefirst@gmail.com are associated with 123.555.0000 in the threshold exceeding contact list. The association in the threshold exceeding contact list may be made even if the contact lists that were aggregated did not exhibit a sufficient level of consensus for the number 123.555.0000 to be included in the threshold exceeding contact list.

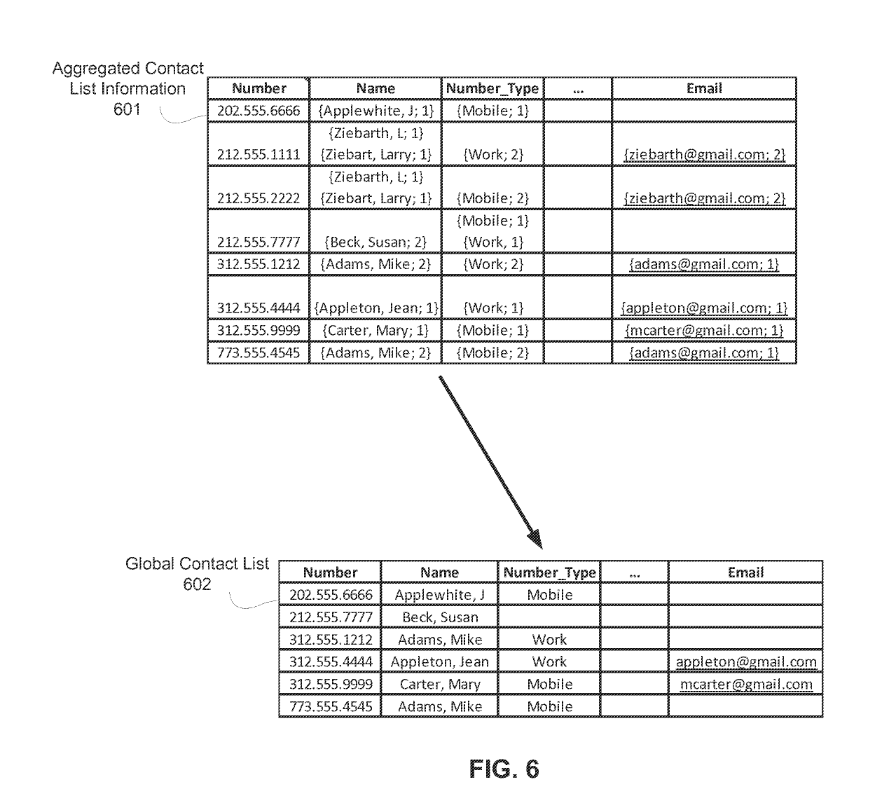

FIG. 6 depicts an example subset of a data structure for an array of aggregated contact list information and an example subset of a global contact list derived from the array of aggregated contact list information. Aggregated contact list information array 601 indexes identifiers for fields associated with several numbers. Aggregated contact list information array 601 is the same aggregated contact list information array as that depicted by element 503 in FIG. 5. Fields associated with numbers in the aggregated contact list information array 601 include a name field, a number type field, and an email field. Other fields that may be associated with a number in an aggregated contact list information array, such as that depicted by element 601, are not shown in FIG. 6. Global contact list 602 is generated from aggregated contact list information array 601. Global contact list 602 is a threshold exceeding contact list where rules defining a threshold level of consensus include a requirement that eighty percent of the contact lists containing a name identifier must contain identical name identifiers in order for the number to be placed on the global contact list 602. Pursuant to that rule, the numbers 212.555.1111 and 212.555.2222 are not included in the global contact list because no unique name identifier is associated with those numbers in at least eighty percent of the contact lists. Additional rules in FIG. 6 require that additional field identifiers be included in eighty percent of the contact lists that contain the number that the additional field identifiers are associated with in order to be included in the global contact list 602. Pursuant to that rule, the email address adams@gmail.com is not included in the global contact list because it appears in only fifty percent of the contact lists containing the numbers 312.555.1212 and 773.555.4545.

At 430, the server receives information pertaining to a caller who originated a call. For example, if call originator 100 places a call to client 102A, clients 102A may receive caller line identification (CLID) information associated with the call originator 100. The CLID information may contain a phone number from which the call originated. Client 102A may then send the CLID information, including the number from which the call originated, to, e.g., server 103. At 430, the server receives, e.g. the CLID information including the number from which the call originated. At 440, the server determines whether the information received at 430 corresponds to a threshold exceeding contact stored in the list of threshold exceeding contacts. For example, if a client, such as one of clients 102, receives a call from 123.555.4444 and sends that number to the server, and 123.555.4444 is found in the threshold exceeding contacts list, then the server determines that the information associated with 123.555.4444 at the threshold exceeding contacts list corresponds to the caller who originated the call to the client. On the other hand, if the client receives a call from 123.555.6666, and 123.555.6666 is not found in the threshold exceeding contacts list, the server is unable to match the caller who originated the call to the client with an entry in the threshold exceeding contact list.

If a match between the information received by the server at 430 and a threshold exceeding contact is identified by the server, then information associated with the matching threshold exceeding contact is transmitted by the server at 450. Information associated with the matching threshold exceeding contact may be shared in a manner in which the user referenced by the information has agreed to, i.e. users may opt-in to having their contact information shared. For example, if the number 123.555.4444 is received by the server at 430, found in the list of threshold exceeding contacts, and associated with the name “Jane Doe,” with the email janedoe@gmail.com, and with an image file, then the name “Jane Doe,” the email janedoe@gmail.com, and the image file may be transmitted by the server. The information may be transmitted to the client who received the call, or the information may be transmitted to another server or another engine within the same server. At 470, the process ends.

In some implementations, further processing may take place at 460. Certain aspects of the further processing may be performed prior to the transmitting of information at 450. Further processing of the information may take place at the client, at the another server, or at the another engine within the same server. The further processing may include displaying the information on the client that reported the information to the server at 430 or displaying a subset of the information on the client that reported the information to the server at 430. In some implementations, the further processing may involve determining that a locally stored contact field identifier should be considered authoritative. Specifically, if a local contact list contains information contrary to information received from a global contact list, the further processing may involve replacing, in the information displayed by the client, the information received from the global contact list with the information stored at the local contact list. For example, if the name associated with a particular number in a local contact list is a nickname or a term of endearment, the nickname or term of endearment may be displayed by the client instead of the name associated with the number in the global contact list. Further processing which involves determining that information stored at a local contact list should be considered authoritative may also involve identifying the type of information, e.g. the field by which the information is classified, identifying the source of the information, identifying details regarding the origin of the information, and applying rules that define the relative authority of conflicting information based on the identified characteristics of the information.

The amount of the information that is displayed may be determined according to account settings, which may include privacy settings, established by, e.g., the client or user account that reported the information at 430. Thus the further processing may also include querying a server or database including such account settings and applying rules and subrules corresponding to such account settings. Account settings may also be established by the user of the client that reported the information at 430, the client corresponding to the number matching the information reported at 430, or the user of the client corresponding to the number matching the information reported at 430. For example, if a client corresponding to a particular phone number prefers that information associated with the client or the user of the client not be disseminated, such a preference may be stored at a server or a database. If such preference is determined to exist, information associated with the particular number may be barred from being transmitted at 450. Alternatively, if the client or user prefers that information associated with the client or user only be disseminated to particular individuals or particular groups, the information associated with the particular number may not be transmitted at 450 unless it is first determined that the recipient of the transmission is one of the particular individuals or a member of one of the particular groups. In alternative implementations, such a user or client preference may act to prevent the server from including the client or user who indicated the preference from being included in the threshold exceeding contact list.

In some implementations, further processing at 460 includes correction of information stored locally at a client, such as one of clients 102, by comparing the information stored locally with information stored at the threshold exceeding contact list. For example, if the information stored at the threshold exceeding contact list is transmitted to a client, and the client has information associated with one or more of the same numbers stored at the threshold exceeding contact list, it may be determined that the locally stored information is inaccurate. For example, if the threshold exceeding contact list indicates that ninety percent of contact lists associate 123.555.8888 with a mobile number, and a particular client locally associates 123.555.8888 with a home number, then it may be that the information stored locally by the particular client is incorrect. Similarly, if the information stored in the threshold exceeding contact list is authoritative by virtue of being provided by a client corresponding to the number with which the information is associated, that fact may be used to indicate that locally stored information is incorrect. In some implementations, further processing involves prompting the client to modify the locally stored information or automatically modifying the locally stored information.

In yet other implementations, further processing may also include a spam detection feature. If CLID information provided by a client to the server at 430 does not match the information stored in the threshold exceeding contacts list, it may be an indication that the client has received a call from a spammer who is engaged in number spoofing.

In alternative implementations of the presently described systems and methods, the threshold exceeding contact list may be pushed by the server to a client or pulled by a client from the server. In such implementations, the determination of whether or not the caller information matches an entry within the threshold exceeding contact list may be performed by the client. For example, an application running on a client or a processor at the client executing computer executable instructions stored on a computer readable medium may determine whether or not CLID information corresponds to an entry of the threshold exceeding contacts list. Similarly, the further processing at 460 may be implemented by an application running on a client or a processor at the client executing computer executable instructions stored on a computer readable medium.

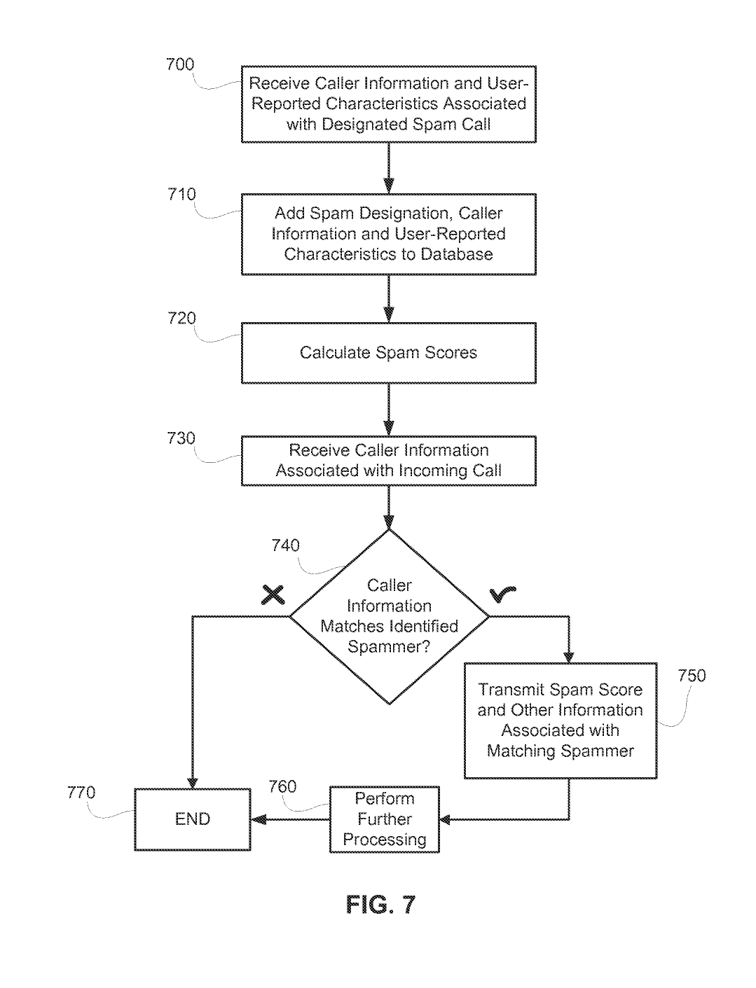

FIG. 7 is a flow diagram illustrating an example method for detecting spam calls through crowd sourced call identification. At 700, a server receives, from a client, e.g. one of clients 102, information corresponding to a caller who has originated a call to the client. The information may include information about the caller who originated the call as identified from caller line identification (CLID) information and may also include information provided by the client or information originating from a user, such as one of users 101. For example, information provided by the client or the user may include but is not limited to an indication that the call was spam, that the call constituted a political fundraising attempt, or that the call was from a charitable organization.

At 710, a spam designation, caller information, and user-reported characteristics of a spam call are added to a database. In some implementations, the database may index spam reports by phone number. In such implementations, information stored at the database may include but is not limited to a tally of the total number of spam designations associated with each unique phone number, user-reported characteristics of the spam associated with each unique number, and caller line identification (CLID) corresponding to calls designated as spam originating from each unique number. At 720, spam scores are calculated for each unique number stored at the database.

At 730, the server receives caller information associated with an incoming call to a client. At 740, the server determines whether the caller information associated with the incoming call matches information associated with an identified spammer. If it is determined that the caller information associated with the incoming call matches information associated with an identified spammer, the spam score and other information associated with the identified spammer are transmitted at 750. The information may be transmitted to a client, to a another server, or to another module of the same server. Once the information has been transmitted, further processing may be completed at 760. Further processing may include determining, based on local client preferences, global system preferences, or a combination thereof, whether the call should be processed as spam or non-spam or as a particular category of spam. At 770 the process ends.

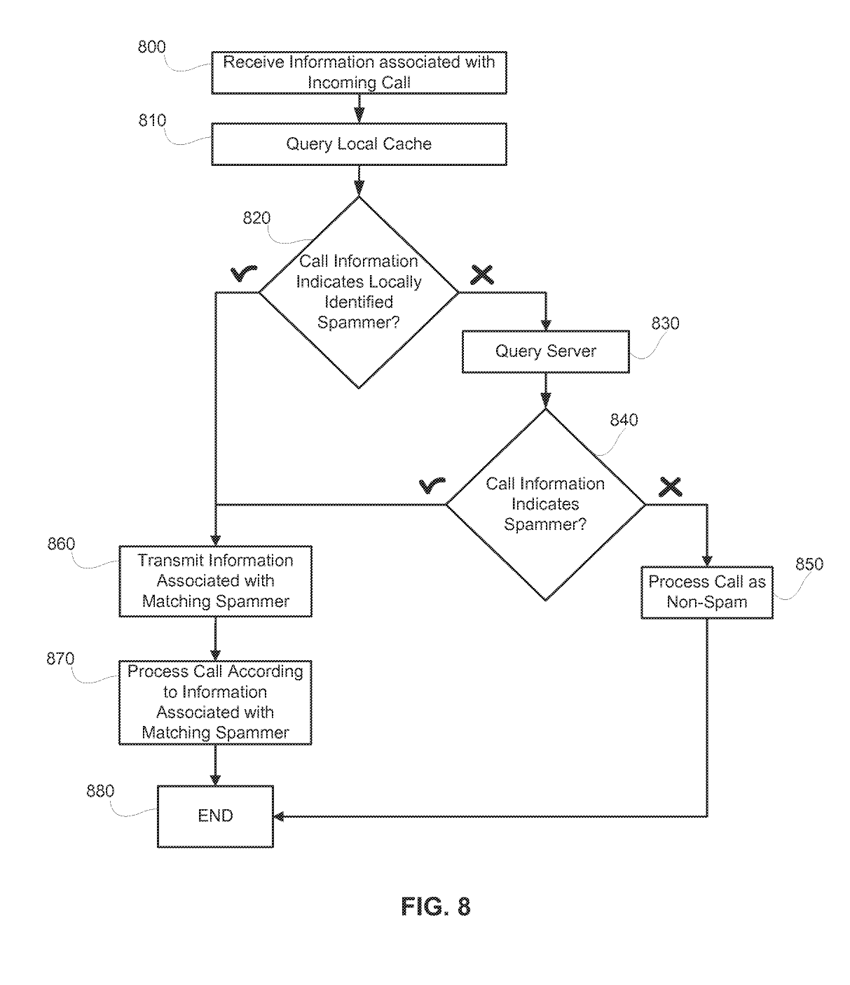

FIG. 8 is a flow diagram illustrating an example method for processing an incoming call. At 800, information associated with an incoming call is received. Such information may include information included in a caller line identification (CLID). Information received at 800 may include a phone number identifying the network element from which the call originated and a text line describing the network element from which the call originated. For example, the information received at 800 may include the number 111.555.2222 and the name “Thomas Jefferson.” At 810, the local cache at the client receiving the call is queried with the information received at 800. At 820, it is determined whether or not the information received at 800 is indicative of a locally identified spammer. For example, if a client had previously received a call from 123.555.9999 and locally designated the number 123.555.9999 as a spammer, then a call received from 123.555.9999 could be locally identified as a spam call.

If the call information received at 800 does not indicate a locally identified spam call, then at 830, a server is queried with the call information received at 800. At 840, it is determined whether or not the information received at 800 is indicative of a spammer identified by the server. For example, if a particular client receives, for the first time, an incoming call from 123.555.1111 and hundreds of other clients had previously received calls from 123.555.1111 and indicated such calls to be spam, the particular client may be able to determine that the incoming call from 123.555.1111 is spam by querying the server. In some implementations the server may be able to provide information about the caller even if the caller has not been identified as a spammer by virtue of having maintained a global contact list, such as the threshold exceeding contact list described supra. If the call information does not indicate a spammer identified by the server, then call is processed as non-spam at 850 and the process ends at 880. However, if the call is identified as spam by either the local cache or the server, then the process proceeds to 860.

At 860, information associated with the matching spammer is transmitted. In different implementations, the information may be transmitted to an application running on the client or to an application running on a remote server. At 870, the call is processed according to the information associated with the matching spammer. Such information may include the spam score of the matching spammer. Additional information may also be used to process the call. For example, the preferences of the client, such as one of clients 102, or the user, such as one of users 101, may be used to determine the appropriate manner for handling the call. At 880, the process ends.

It is contemplated that other implementations may differ in detail from the foregoing examples. As such, all references are intended to reference the particular implementation being discussed at that point in the description and are not intended to imply any limitation as to the scope of the invention more generally. All language of distinction and disparagement with respect to certain features is intended to indicate a lack of preference for those features, but not to exclude such from the scope of the invention entirely unless otherwise indicated.

For situations in which the systems discussed here collect personal information about users, or may make use of personal information, the users may be provided with an opportunity to control whether programs or features collect personal information (e.g., information about a user's social network, social actions or activities, profession, a user's preferences, or a user's current location), or to control whether and/or how to retrieve content (i.e., recorded voicemails) from a content server (i.e., a voicemail server). In addition, certain data may be anonymized in one or more ways before it is stored or used, so that personally identifiable information is removed. For example, a user's identity may be anonymized so that no personally identifiable information can be determined for the user, or a user's geographic location may be generalized where location information is obtained (such as, for example, to a city, ZIP code, or state level), so that a particular location of a user cannot be determined. Thus, the user may have control over how information is collected about him or her and used by the systems discussed herein.

The use of the terms “a” and “an” and “the” and “at least one” and similar referents in the context of describing the disclosed subject matter (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or example language (e.g., “such as”) provided herein, is intended merely to better illuminate the disclosed subject matter and does not pose a limitation on the scope of the invention unless otherwise claimed. No language in the specification should be construed as indicating any non-claimed element as essential to the practice of the invention.

Variations of the embodiments disclosed herein may become apparent to those of ordinary skill in the art upon reading the foregoing description. Skilled artisans may employ such variations as appropriate, and the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A method for constructing a crowd-sourced global contact list, the global contact list comprising one or more contacts, one or more fields associated with each contact, and an entry corresponding to each of the one or more fields, the method comprising:
aggregating information stored at one or more local contact lists;
determining, from the aggregated information, a set of unique identifiers, wherein each unique identifier corresponds to a single contact;
determining, for each contact, a set of entries for each field associated with the contact, wherein each entry is associated with the unique identifier defining the contact in one or more of the local contact lists;
determining, for each contact, whether a consensus entry exists for each field associated with the contact, wherein a consensus entry exists if a unique entry is associated with the unique identifier in a threshold percentage of the local contact lists that contain the unique identifier; and
populating each field for each contact in the global contact list for which a consensus entry exists with the consensus entry corresponding to that field.

2. The method of claim 1, wherein the unique identifiers are phone numbers.

3. The method of claim 1, wherein entries that exhibit a sufficient degree of similarity are collectively considered to be a single unique entry.

4. The method of claim 3, wherein entries exhibit a sufficient degree of similarity if the entries exhibit one of the group consisting of: a checksum match, a sounds-like match, a phonetic match, and a fuzzy match.

5. The method of claim 4, wherein a sounds-like match includes a match identified by one of the group consisting of: a Levenstein distance algorithm, a Soundex algorithm, and a Metaphone algorithm.

6. The method of claim 1, further comprising:
populating each field for each contact in the global contact list for which a consensus entry does not exist with a null value.

7. A system for constructing and maintaining a crowd-sourced global contact list, the global contact list comprising one or more contacts, one or more fields associated with each contact, and an entry corresponding to each of the one or more fields, the system comprising:
a server, configured to receive local contact list data, to aggregate local contact list data, to determine, from the aggregated local contact list data, a set of unique identifiers wherein each identifier corresponds to a single contact, to determine, for each contact, a set of entries for each field associated with the contact wherein each entry is associated with the unique identifier defining the contact in one or more of the local contact lists, to determine, for each contact, whether a consensus entry exists for each field associated with the contact wherein a consensus entry exists if a unique entry is associated with the unique identifier in a threshold percentage of the local contact lists that contain the unique identifier, and to populate each field for each contact in the global contact list for which a consensus entry exists with the consensus entry corresponding to that field; and
a database, configured to store local contact list data and the global contact list data.

8. The system of claim 7, wherein the unique identifiers are phone numbers.

9. The system of claim 7, wherein entries that exhibit a sufficient degree of similarity are collectively considered to be a single unique entry.

10. The system of claim 9, wherein entries exhibit a sufficient degree of similarity if the entries exhibit one of the group consisting of: a checksum match, a sounds-like match, a phonetic match, and a fuzzy match.

11. The system of claim 10, wherein a sounds-like match includes a match identified by one of the group consisting of: a Levenstein distance algorithm, a Soundex algorithm, and a Metaphone algorithm.

12. The system of claim 7, further comprising:
populating each field for each contact in the global contact list for which a consensus entry does not exist with a null value.

13. A method implemented at a computer readable medium for providing caller identification information to a recipient of a call, wherein the caller identification information is generated from a crowd-sourced global contact list, the method comprising:
receiving a notification that a call was placed to a called client;
receiving information pertaining to a caller that placed the call;
identifying, from the information pertaining to the caller, a contact in the crowd-sourced global contact list; and
transmitting information pertaining to the caller to the called client.

14. The method of claim 13, wherein the method further comprises:
determining that the called client is not permitted to receive all of the information stored in the crowd-sourced global contact list pertaining to the caller;
determining a subset of the information stored in the crowd-sourced global contact list pertaining to the caller that the called client is permitted to receive; and
transmitting the subset of the information stored in the global contact list that the called client is permitted to receive to the called client.

15. The method of claim 14, wherein the subset of the information stored in the global contact list that the called client is permitted to receive includes one of the group consisting of: an email address, a social network profile, a telephone number, a photo, an identity of a user account, and a user alias.

16. The method of claim 14, wherein determining that the called client is not permitted to receive all information stored in the crowd-sourced global contact list pertaining to the caller involves determining that the called client is not a member of a social network of the caller.

17. The method of claim 13, further comprising:
determining that a contact in a local contact list associated with the called client corresponds to the caller; and
determining that information pertaining to the caller stored at the local contact list differs from information pertaining to the caller stored at the global contact list.

18. The method of claim 17, further comprising:
transmitting instructions to the called client to display a prompt to revise the information pertaining to the caller stored at the local contact list.

19. The method of claim 17, further comprising:
determining that the information pertaining to the caller stored at the local contact list should supersede the information pertaining to the caller stored at the global contact list for caller identification purposes; and
transmitting instructions to the called client to display the information stored at the local contact list.

20. The method of claim 13, further comprising:
transmitting instructions to the called client to add the information pertaining to the caller to a local contact list associated with the called client.
